(19) United States
(12) Patent Application Publication
(10) Pub. No.: US 2023/0057112 A1
(43) Pub. Date: Feb. 23, 2023

(54) SYSTEM AND METHOD FOR PRODUCING A SOURCE OF CONSUMABLE WATER EITHER THROUGH FILTRATION OR DESALINATION

(71) Applicant: Ansa Technologies, Pompano Beach, FL (US)

(72) Inventors: Waldemar S Sawicki, Coconut Creek, FL (US); David Tristan Antelo, Boca Raton, FL (US); Dominika Kamilla Sawicki, Coconut Creek, FL (US)

(73) Assignee: Ansa Technologies, Pompano Beach, FL (US)

(21) Appl. No.: 17/973,834

(22) Filed: Oct. 26, 2022

Related U.S. Application Data
(63) Continuation-in-part of application No. 16/239,966, filed on Jan. 4, 2019, now abandoned.
(60) Provisional application No. 62/613,790, filed on Jan. 5, 2018.

(51) Int. Cl. C02F 1/00; C02F 1/26

(52) U.S. Cl. CPC C02F 1/001; C02F 1/265; C02F 2201/008; C02F 2303/04; C02F 2201/005; C02F 2209/10

(57) ABSTRACT

A universal water purification system and method that can desalinate salt water or just filter fresh water. Preferably, the system is portable and relatively lightweight and provides for emergency or recreational safe power and water accessibility. The components of the system can be installed on an aluminum frame and preferably include one or more of a waterproof front control panel, four pre-filters, a reverse osmosis membrane or graphene filter, or electrical process of separating chloride ions from water, ultraviolet (UV) LED lamp, ultrasonic frequency generator, chlorinator or disinfecting gas infusion, a high pressure reverse osmosis (RO) pump, or other desalination process and a low pressure water supplying pump, an electro valve preferably with a manual override in case of power loss and can be activated based on the content of total dissolved solids of incoming water. The system may be removably inserted into a suitcase that can be carried by an individual, or housed in a frame with wheels.

This application is a continuation in part of U.S. patent application Ser. No. 16/239,966, file Jan. 4, 2019 which claims the benefit of and priority to U.S. Provisional Patent Application Ser. No. 62/613,790, filed Jan. 5, 2018, which is incorporated by reference in its entirety for all purposes.

### 1. FIELD OF THE DISCLOSURE

The disclosure generally relates to portable water treatment methods and in particular to a portable water treatment method and system that produces a supply of consumable water under various types of conditions, as well as providing for a universal power supply and battery charger.

### 2. BACKGROUND OF THE DISCLOSURE

Current portable systems for providing consumable water suffer from one or more of the following problems: (a) not knowing the type of water source and therefore not knowing whether filtration or desalination is needed; (b) not having a power source available for powering the system; (c) filtration capability using standard media; (d) not being able to reach the water source due to distance, elevation or a well water source; (e) powering of a long distance water pump; (f) having untrained persons operating the water purification equipment; (g) having contaminated water getting through damaged membranes; (h) issues with replacing internal lithium batteries; (i) issues with having floating debris at the surface of the water source versus having mud at the bottom of the water source; (j) the weight of the reverse osmosis (“RO”) membrane housing; (k) replacing the RO membrane out in the field; (l) determining whether the filter, such as a Nephros filter, is correctly installed or needs to be flushed; (m) determining the status of any pre-filters or if they are correctly installed; (n) determining proper connections for the hoses used with the system; (o) water leaks in the system case or housing when one or more of the hoses are removed; (p) issues with accessing the internal components of the system; (q) issues with fastening or securing the system to a protective case; (r) issues with having contaminated water becoming mixed with clean water; (s) potentially dangerous electrical currents inside the unit or system; (t) fragile ultraviolet (“UV”) lamps breaking during transport; (u) insufficient contact time for the water inside the UV lamp; (v) issues with extended range water sources; and (w) issues with regard to handling and mobility.

Additionally, with the water and power supply infrastructure aging, and with natural disasters on the rise, down time in both available consumable water and power delivery to homes has also increased in frequency.

The disclosed novel system and method is directed to overcoming or reducing the above-noted problems with current portable systems for producing clean potable drinking water.

### SUMMARY OF THE DISCLOSURE

A portable water purification unit is disclosed that can operate as a filtration or desalination system to produce potable water. The unit is preferably contained within a hard-shell and/or rugged case suitable for harsh and several types of environments. In one non-limiting embodiment, the system, along with the case, can weigh less than one hundred (100) pounds and preferably less than 98 pounds, such that it can be easily hand-carried by two individuals out in the field and in use. In one non-limiting example, the hard-shell/rugged case can be a rugged case including, but not limited to, one or more of the rugged cases offered by Pelican Products, Inc. and sold under the PELICAN brand name.

Preferably the system can be powered by any outside electrical source (such as a generator) and may also be powered with an internal, removable, rechargeable battery pack or internal power generator. The system can draw water from a distance, such as, but not limited to, from around 200 feet away, through the use of a positive displacement pump or any device that causes water to flow or be inserted into the system. The system can be configured or designed such that it can filter water down to preferably 0.05 micron without the use of any power. The system can use a light emitting diode (“LED”) ultraviolet (“UV”) light as one of the preferred multi-filtering stages.

The disclosed novel system and method provides the ability to perform either desalination including, but not limited to, reverse osmosis (RO), graphene, any other methods of removing Total Dissolved Solids (TDS) or filtration by a single system, with the system having different pathways for each capability (purification/desalination and filtration). The system can preferably filter at a 0.05-micron level in its filtration mode, which is preferably separate from its desalination/purification mode at a 0.0001-micron level.

### BRIEF DESCRIPTION OF THE DRAWINGS

FIG. 1 is block diagram and process flow of the preferred embodiment for the system and method in accordance with the present disclosure;

FIG. 2 is a perspective view of a preferred embodiment of the system/unit in accordance with the present disclosure;

FIG. 3 is a perspective view of the system/unit of FIG. 2 shown disposed within a preferred hard shell/rugged case for hand carrying the system/unit in accordance with the present disclosure; and

FIG. 4 is a perspective view of the preferred system/unit of FIG. 2 shown disposed outside of the hard shall/rugged case of FIG. 3.

### DETAILED DESCRIPTION

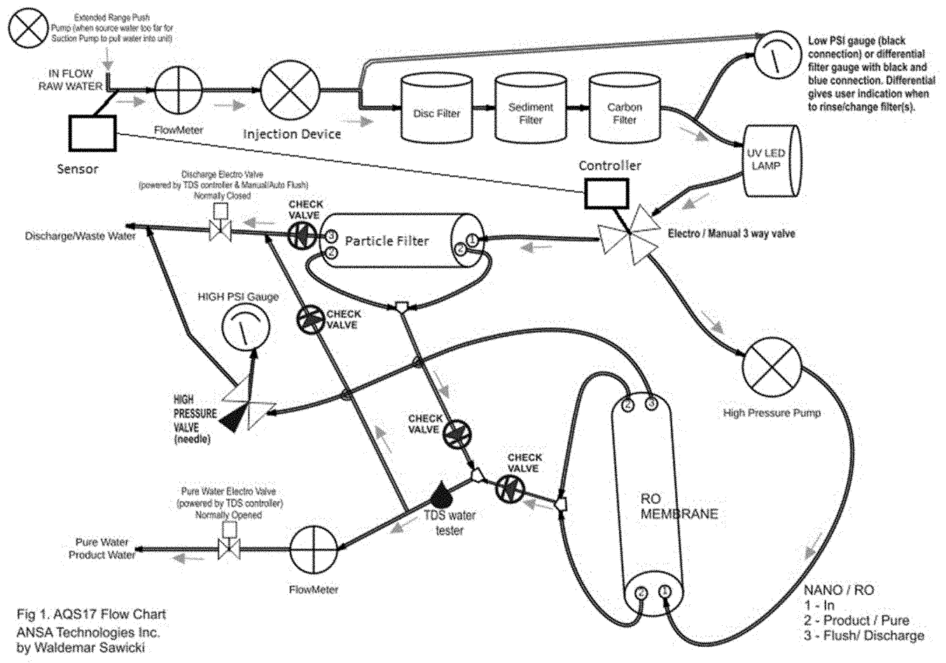

As seen in the drawings a preferred embodiment and method for the disclosed novel system and method for producing consumable water and serving as a filtration or desalination system to produce potable water, while also serving as a power source, is shown. FIG. 1 shows a preferred configuration/system layout/schematic for the novel system and method.

A water inlet hose/pipe/conduit for taking in (in flow of) water from a water source can be provided for introducing water into the system for filtration or desalination depending on the nature or physical characteristics of the water (i.e., dirty, or contaminated water, saltwater, dissolved solids, etc.). A water injection device, such as a suction pump can be provided to pull and/or draw the water into the system via a main line for processing. The water injection device can be substituted with, and includes any device to introduce water into the unit/system, including but not limited to, the suction pump (also referred to herein as a “main pump”), a fluid pump, a push pump, tap water pressure, a well water pump, an external pump, and a gravity feed water supplying device from an elevated water source. For situations in the field where the source of water is located at a distance from the system such that the suction pump is unable to pull the water into the system, an extended range push pump (positive displacement pump) can be preferably provided at the water source to push the water, preferably through an extended hose/conduit/pipe in communication with the in-flow hose/pipe/conduit, towards the system where the suction pump can then pull the water into the system or the external push pump can push the water into the system. Accordingly, the inlet water flow is preferably pumped into the unit/system by the internal suction pump and/or a preferably long distance, low-voltage, external intake pump that can be used to draw sources of water remotely located from the system. In one non-limiting embodiment, the external intake pump can be used to feed water into the system from water sources located up to approximately 200 yards from the location of the system. In another non-limiting embodiment, the length can be approximately 200 feet. Other lengths can also be used and all are considered within the scope of the disclosure. However, this distance is not considered limiting and other distances can be selected and types of pumps can be selected and are considered within the scope of the disclosure. Preferably, the intake is accomplished through the use of hoses, that can be connected through the use of a quick connect hose couplings on a front panel of the system (1 of 3 available for external connection, but not limited to, and each being preferably different to avoid mistakes).

Once the water has entered the system it flows through a path of one or more filters (or may not be filtered at all), which can be in one implementation three filters preferably provided with see-through filter housings. The water may be filtered prior to entering the system or may be filtered externally. The filter cartridges can include a disc filter, a sediment filter and a carbon filter or any combination of the above. However, such is not considered limiting and any other number or types of filters can also be provided in addition to the disc, sediment and/or carbon filter or in lieu thereof and are also considered within the scope of the disclosure. As a non-limiting example, other filters or media cartridges needed for a raw water problem can also be used and provided. Additionally, though FIG. 1 shows the filters in a particular order of disc, sediment and carbon, such order is not considered limiting and the filters provided can be provided in other configurations and all are considered within the scope of the disclosure. Preferably, the filters are accessible in the front of their respective or corresponding housings such that they are easy to replace or rinse without having to remove the entire purification unit from the case. Furthermore, in a preferred but not limiting embodiment, the disc filter can be held by a top to bottom fastening mechanism to allow it to fit a 5-inch or any standard filter housing. A pressure gauge or differential filter gauge can also be preferably provided at the input and output of the filters to provide the user with an indication/notification when one or more of the filters need to be rinsed or changed. In one non-limiting embodiment, an alarm/display (audible or visual) may be in communication with the gauge(s) to further provide notification to the user of the need to rinse or change one or more of the filters. In addition to a read-out of the gauge, the display may have the capability to provide a signal to the valves and/or pump to shut off the entire system if the filters are too fouled.

After the water has gone through the above-referenced multi-stage initial filtering, the filtered water can be directed to and exposed to an ultraviolet (UV) light module, which in a preferred but not limiting embodiment can be a UV LED lamp. The UV LED lamp can be provided with an aluminum radiator and cooling fan and is provided to sterilize the water before it reaches particle filtration (although nano filtration using a nano-filter is suggested, filtration may be any level or type of particle filtration including, but not limited to, micro filtration using a micro-filter, or ultra-filtration using a ultra-filter) or reverse osmosis “RO” or other desalination devices (including, but not limited to graphene, ceramic tubing, and carbon nanotubes (“CNT”)) in the purification/desalination stage. A UV lamp signal light/controller can be provided to show or otherwise indicate that the UV LED lamp is working properly. Although a UV light module or UV LED lamp is shown as a disinfecting device to disinfect the water, other devices may be substituted for the UV light module/UV LED lamp such as an ultrasonic frequency generator that generates ultrasonic frequencies that disinfect water. Furthermore, a disinfecting liquid or gas injector which injects chlorine, ozone, a reducing gas, or any residual disinfectant in the water may also be substituted for the UV light module/UV LED lamp to disinfect the water.

After being sterilized by the UV LED lamp or other disinfecting device, the water flow schema (in conjunction with a valve such as a multi-direction/electro/manual/automatic 3-way valve) allows the operator/user to choose between a higher flow particle filtration product water or a lower flow RO purified/desalination selection. In a default setting, the system can be configured such that the water flow through the electro/manual valve is directed into the particle filtration which can be preferably positioned under the 3 pre-filter housings, though such position is not considered limiting. The particle-filtration can also be housed within a see-through housing, such as, but not limited to a heavy-duty polycarbonate housing. The housing can be provided with specially designed endcaps to allow for a double side pure water flow. With one side being the “in flow” and the opposite side being a flush “out flow”.

When in the default setting which can preferably be the particle filtration mode, a flush valve timer can turn the flush electro valve “on” for an initial flush of the particle filter (i.e. particle-filter offered under the brand name NEPHROS or other similar sub-0.05 nano-filter, micron-filter, etc.) for a set or predefined length of time. The length of time can be adjusted by the operator/user where needed or the flush can be manually turned on by pressing or otherwise selecting a flush button/control preferably located on the control panel for the system.

In situations where no external power source, or any other electrical power source, is available and the battery preferably provided with the system is drained or depleted, the system can still be used for filtering water, where the external water source flows into the system/unit at a water pressure preferably above about 10 psi (i e similar to at least the psi from a kitchen/bathroom/garage/garden tap or a tank placed at a higher elevation for gravitational flow). In such situations, a plug with direct access to the filter(s) can also be provided and the UV LED lamp can be powered through a preferably supplied small solar panel or other external power source.

Where reverse osmosis/desalination of the water is desired preferably the desalination option button is pressed or otherwise selected by the operator/user, though, it is also within the scope of the disclosure to have the desalination selection be the default setting and the operator/user select a filtering option for particle-filtering of the water instead of desalination. However, with the particle-filtering set as the default, by selecting the desalination option, the filtration/purification valve (i.e. electro/manual 3-way valve multi-directional valve which may include one or more two 2-way valves, or multiple single valves) redirects the water flow into the line with the high-pressure pump or other flow sequence to desalinate or remove total dissolved solids (TDS) (e.g. water containing total dissolved solids over 1000 ppm) or suspended solids. The valve can be manually changed by the operated/user to also create the redirect of the water when power is not available to actuate the electro valve. Such selection of the desalination option or the particle-filtering option may be automatically set by a controller based on and in response to sensing a presence of a predetermined threshold/amount of total dissolved solids such as salt or other substances (or other chemicals/bacteria) in the water as described herein. In another implementation, a VFD e.g., a variable pressure regulator can be provided to increase pressure (from the RO unit) depending on the level of TDS. Specifically, one level of pressure is provided into the line with the high speed pump with full ocean water. But brackish water may be provided into the line with a lower level of pressure.

Though not considered limiting, the high-pressure pump's motor RPM cycles can be set to 1200 or about 1200. However, based on certain conditions or desires, flow can be increased by increasing the RPM, such as, but not limited to, a preferred maximum of 1400 RPM or about 1400 RPM or the RPMs can be decreased to 1200 RPM to save energy. Preferably, the pressure of the pump and flowrate can be regulated by a high-pressure valve on the system control panel. An hour counter can be provided on the control panel and used to count the high-pressure pump's operational hours for oiling and any other required maintenance. Incoming low-pressure values and the desalination high pressure values can be displayed on the front panel of the control panel using gauges or other displays, such as LED displays.

The housing for the desalination membrane can be constructed from a combination stainless steel, polycarbonate and carbon fiber material to maintain the system's durability and light weight. However, other materials such as graphene, carbon nanotubes that will also achieve these characteristics can also be used and are considered within the scope of the disclosure.

Three quick connect hose couplings can be installed on the front panel for easy hose connection for intake, discharge and product water. In a preferred embodiment, each of these connections can differ from the other connections in some manner such as male/female fittings, hose sizes, or any other such variations/differences provided to help eliminate or at least reduce mistakes of connecting a wrong hose to the wrong water line.

The system can be used for various purposes including, without limitation, for emergency and/or recreational purposes and can be provided within a rugged case, such as, but not limited to, a Pelican type suitcase. The system can be installed on an aluminum frame structure on a mobile platform with wheels, with a control panel and a back panel behind the filters for safe and quiet operation. The portable, rolling-capable water maker (particle filtration or desalination purification/RO desalination unit) and power supply unit (i.e. a removable battery Power Bank, power generator, universal Power Source, large array Battery Charger) apparatus can preferably be designed for safety, portability, durability and universal application. The frame can be designed to fit within the case (i.e. the military/Pelican type suitcase), preferably with no changes needed to be made to the case. The system frame and body can easily be removed from the case by two handles preferably provided on the front frame panel (top and bottom). The integrity of the case (i.e. buoyancy, waterproof, dust proof features) is not changed as the case is not altered. When desired, handles on the case or frame can be used to increase ease of carry.

Various check valves can be provided with the various water lines flowing out of the particle—filter and desalination membrane to ensure that cleaned water is not mixed with contaminated or salt water.

The battery pack or Power Bank provided can be enclosed in a heavy-duty case with a handle and can be removed from the system. The waterproof plug(s) Power Bank and fuse can be removed (slides out) by its handle from the system frame. This Power Bank can be charged by internal charger/inverter or external power supply or can internally or externally supply power. The Power Bank, Supply Power, Battery Charger operational features can be displayed on the front panel with LED display, battery charge indicator, AC/DC waterproof input/output plugs and fuses. Preferably all of these are allocated on the front control panel.

In a preferred non-limiting embodiment, the unit Power Bank can use high performance 12V, 512 WH LiFeP04 batteries with a balancer. However, other, or alternative batteries can be used and are also considered within the scope of the disclosure. The system/unit can also be powered by external AC about 90-260V 40-90 Hz, 12V, 24V, etc. However, the voltage and Hz (frequency) range can also vary or be slightly altered from the values stated herein. The unit/system can supply power to: USB 2.1 amp, 12V (25 amp), 24V (20 amp) and 110/230V through external converters. Preferably, the 110/230V, 12V, 24V plugs can all differ with the available adapters to eliminate errors.

For the UV LED lamp, a series of LED lights preferably between about 245 and about 265 nm can be arranged in a serpentine style to maximize contact time between the UV light and the water. The water pathway may include a second pass of water through the LED bulbs. A proprietary sensor can be provided to measure the amount of light in the LED housing. Therefore, if the water is irradiated below a certain threshold, the UV LED controller may shut off the unit leaving only an illuminated light indicating there is a UV problem. The LED housing can be designed to withstand high heat and impacts by utilizing heat dissipation manifold and preferably completely insulated electrical connections.

Thus, disclosed herein is a portable, easy to operate, lightweight, safe system that supplies power and water on the go, in emergency, recreational or extreme situations. This system provides for both (a) a water treatment method through a series of stages resulting in particle water filtration and RO purification/desalination (though preferably not both at the same time) and (b) an optional power bank, universal power supply and a wide range battery charger. Accordingly, the system provides for self-sufficiency and immediate and safe access to both power and water. The Power Bank, preferably using safe and long-lasting lithium LiFeP04 batteries with balancer, can be designed to hold a charge for an extended period and have a long cycle life. The power supply can accept power to charge the power bank or run the water system from 90 to 260 V, 40 to 90 Hz and can be used or sent anywhere in the world for quick assistance. In one implementation, the battery charger can charge 11 different battery types for car or even truck needs, (exact voltage, Hz and number of battery types can be increased for more power). The preferred low voltage, low amp pumps, electro valves, and UV LED Lamp (or one of the aforementioned disinfecting devices) allow the water unit/system to be safe and consume low energy. With the available power, the disclosed novel water treatment system and method produces maximum safe water for specific needs, with the operator having the option between particle-filtration and pure water RO purification/desalination treatment. The disclosed system is convenient to operate and aids in survival for the operator.

In summary, disclosed is a portable, hand-carriable, suitcase emergency/recreational portable system preferably comprising of a portable power and water maker, and a removable and replaceable battery bank of LiFe batteries (or other internal power source such as a power generator). The system can be provided with a universal power source that can be fed by 12-24 V, 90-240 V, power source in one non-limiting embodiment. In a preferred, non-limiting embodiment, the system can be provided with a 25-amp battery array Battery Charger. The system can also provide for water nano particle filtration preferably using any P-248 approved filter that can filter down to 0.005 micron. An internal UV LED sterilization, ultrasonic frequency sterilization, ozone, post filtration filter, reducing gas, or chemical sterilization and an RO purification/desalination device can also be provided. Preferably the system can be selectively switched from just filtration mode or to full desalination mode with one button/switch. Default settings for either filtration or desalination can be configured with the system.

Alternatively, a salination or TDS sensor (e.g., a Proportional Integral Derivative (PID) loop) may be present on the water intake (or main fluid line) to detect the presence or absence of total dissolved solids. A controller may be connected to the salination sensor. In response to chlorides, or high TDS levels are detected at or above a predetermined level (or threshold in the water intake and/or the main fluid line, the multi-directional switch can be set to automatically switch (e.g., by opening or closing a valve) to direct water to the RO purification/desalination device (full desalination mode). In response to TDS, chlorides is detected below a predetermined threshold or level in the incoming water by the salination sensor, the multi-directional switch can automatically direct water to the a filter system containing at least one of an internal filter, a UV LED sterilizer, an ultrasonic frequency sterilizer, or a device that injects ozone, reducing gas, and/or a chemical (e.g. chlorine), or a sterilization devices (just filtration mode, e.g. in one implementation a simple prefilter and desalination process (not necessarily RO) is used without any post treatment like UV, Ozone, reducing gas, ultrasonic, or chlorine). Once the fluid has passed through the RO purification/desalination system or the filter system, or exits the particle filter the fluid (wastewater) can be outputted to an output line.

The various electronic/electrical components system can be powered by generator, battery and/or through plugging an electrical cord into an electrical outlet (when and where available).

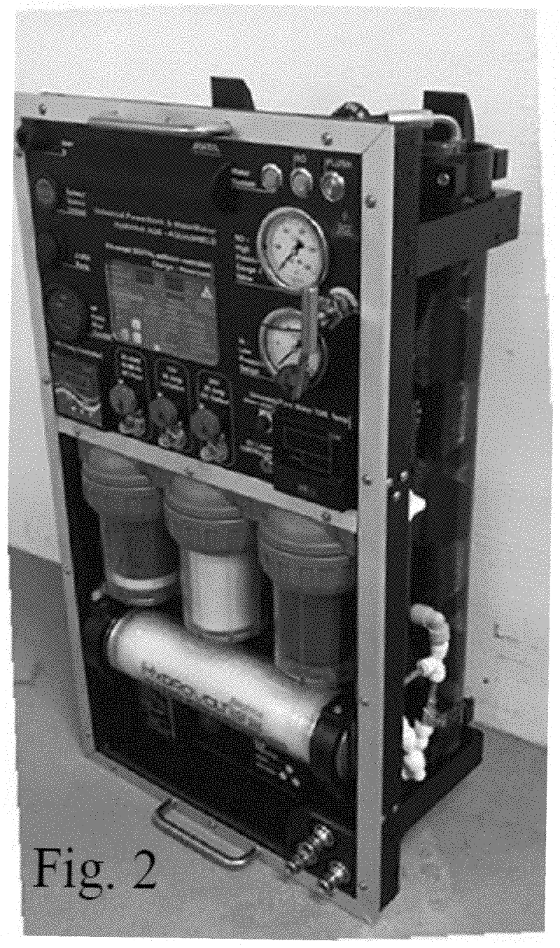

FIG. 2 shows a preferred, though non-limiting, frame or housing that can be used for containing/securing the various components of the system. Preferably, the frame/housing can include various open areas for visually inspecting and viewing/removing/replacing/maintaining at least several of the components of the system. A control panel can be provided as part of the frame/housing where the operating/control buttons, levers, knobs, valves, manual valve controllers, Bluetooth, touch screen, remote short message stream (SMS) etc. can be provided for operating the system. The pressure (high and low) and other gauges, as well as other analog or digital displays, screens, etc. can also be provided on the control panel and the output of the data displayed on the screen may be transmitted via Bluetooth or SMS text.

In one implementation, when the frame/housing containing the system is vertically positioned (as in FIG. 2), the preferred three pre-filters (disc filter, sediment filter and carbon filter) all positioned downward and next to each other, and the preferred particle-filter horizontally positioned and underneath the three pre-filters.

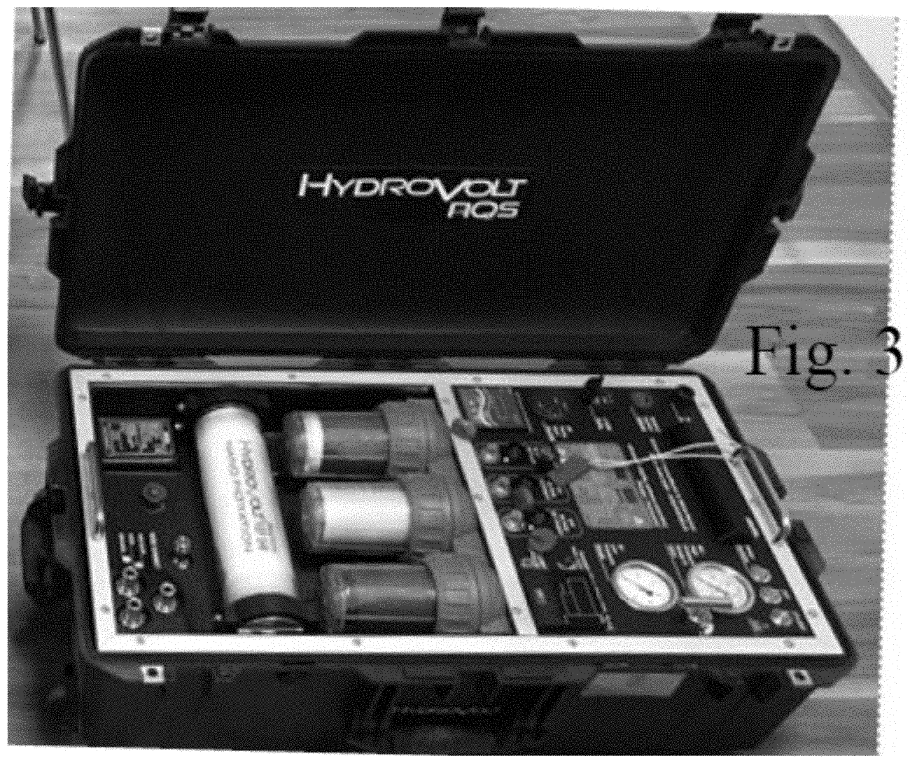

FIG. 3 shows the system/frame contained within the case and handles extending outward/upward for easy removal from the case. Though the frame handles extend outward/upward, there is preferably enough room/clearance in view of the shape of the case's cover to allow the cover to be properly closed to fully close the case with the system/frame contained inside. The case is preferably provided with one or more handles, and preferably at least two handles for ease of transport and to allow to individuals to carry/transport the system (contained within the case) to its desired end location.

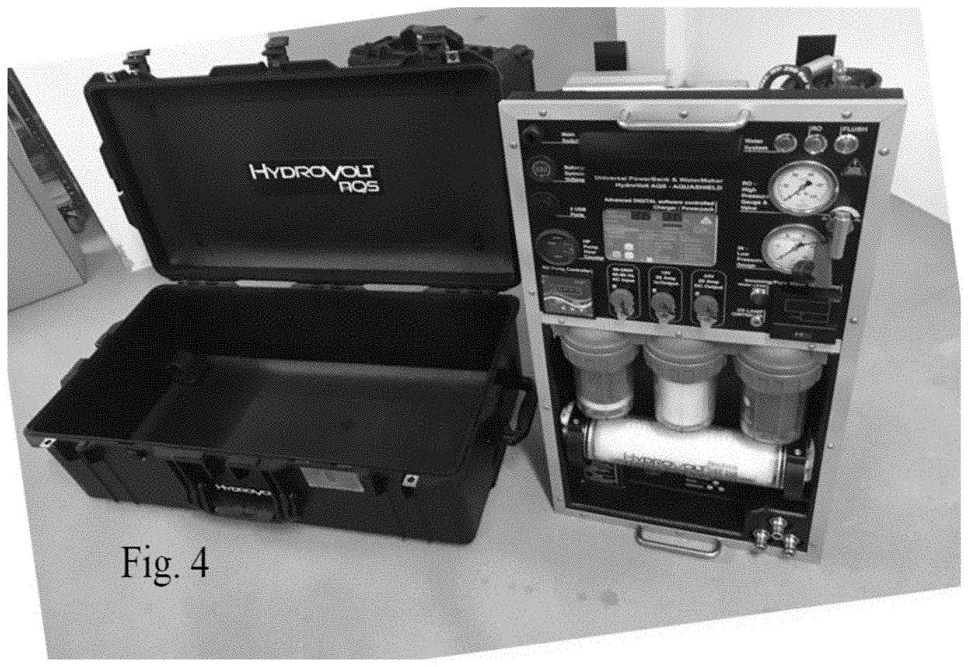

As best seen in FIG. 4, the system/apparatus/unit can be installed on a frame preferably with a front panel and the frame can preferably be contained within a rugged suitcase/case (i.e., PELICAN or similar type case, etc.). Preferably two handles extending outward from the frame/housing allow the entire device (frame with system secured thereto) to be removed from the Pelican type case for maintenance, removal of the power bank, case replacement, etc.

The system can function via command switches with the aid of monitoring devices (for example flowmeter, pressure gauges, volt, amp reader, fuses, high pressure pump hour counter, UV lamp controller, etc.) on the front panel or elsewhere on the unit. Front access to see-through housings for some or all of the filters/cartridges can be provided for monitoring/quick replacement. Preferably, no changes are needed to standard rugged cases that may be used to house the system, as the system/device installed on the frame with front panel and front cover preferably fits within a standard lightweight military/Pelican type case. The rugged case continues to maintain any waterproof, dust proof and buoyancy properties it normally contains.

Depending on the type of water source or the quality of water needed, the flow can be directed via the larger flow at less power consumption particle filtration, or the higher quality product water and higher energy usage of the RO purification/desalination treatment. Automated and manual flush function preferably works only in default filtration mode. When no electrical or battery power is available, the unit can be connected to an external water source with pressure (i.e. kitchen/bathroom/garden/tap or a gravity feed container that is elevated) and the natural pressure of the flowing water will allow the water to pass the pre-filter(s), UV LED Lamp (preferably being solar powered) and particle filter with no electrical or battery power supplied. The UV LED Lamp can be directly connected to a small solar panel or small battery supplying just enough energy to power the UV LED in such dire situations.

The disc filter of the pre-filter(s) can be held by top to bottom fastening design to fit including, but not limited to, a 5-inch filter housing. The UV LED lamp can be provided with an aluminum radiator and cooling fan for sterilizing water before it reaches particle filtration or desalination purification stage. The particle filter is preferably housed or contained within a see-through heavy duty polycarbonate housing. The housing preferably has specially designed endcaps for double side pure water flow (i.e., one side ‘raw in flow’ and the opposite side ‘out flow’, and a third port “flush outflow.). The RO membrane housing can be made from polycarbonate, or a combination polycarbonate and carbon fiber material to provide for durability and light weight properties. The Power Bank element can have a handle and waterproof plug(s) and can be used as a separate Power Bank when removed from the unit.

The disclosed novel system and method addresses the problems noted in the Background with current portable water treatment system by:

1. The system operates in either filtration or desalination mode, so no pre-decision needs to be made as to what type of treatment system to bring when the type of water source is not known;

2. The system may be provided with an internal lithium battery pack to provide power, where no external power source is available;

3. The filter chosen for filtration can be a NEPHROS or similar filter capable of going down to at least 0.05 micron or ultra-filtration level which is exponentially smaller than any organism, providing effective removal by the filter, and at a higher level of removal as compared to standard media used with current treatment systems;

4. The system can be provided with a separate positive displacement pump which can feed the system/unit from a distance of approximately 200 feet (though not limiting), where the user cannot reach the water source with the system in view of a drop/incline or a well water source. The pump can also serve as a redundancy method for getting water into the system in case the internal suction pump fails;

5. The extended range pump can operate and be powered from the main system/unit using the internal battery pack (or internal power supply/generator) or the external source powering the system, including, without limitation, an outlet or generator. The battery pack, may be provided with the system, and may also be placed at the water source and independently feed the system and power the extended range/long-distance pump;

6. The system can preferably be provided with one key/knob/button operation that can be preset to run full desalination (including by not limited to desalination) process/function. It can then be changed to filtration mode if needed to address the issue where the operator is untrained in the area of water purification equipment;

7. To address problems with contaminated water getting through damaged membranes, the system can be configured to provide for an automatic reroute of product water if it is above an acceptable adjustable threshold in PPM of TDS (Total Dissolved Solids). Preferably, the system shuts off the clean H₂0 hose and all water (wastewater and/or discharge water) is sent to the discharge hose;

8. The preferably provided battery pack can be enclosed in a reinforced case with a handle that can easily be removed from the unit to allow the internal lithium or other type of batteries to be easily replaced when necessary. The battery pack can also serve as an external power source that can be connected to a 12 v outlet to power external equipment such as cell phones, smart phones, tablets, laptops, etc.;

9. To address potential problems of having floating debris at the surface of water source vs. having mud at the bottom of a water source, the extended range pump can either be placed on the bottom of the water source or attached to a floater that maintains the suction or positive displacement pump just below the surface of the water;

10. The combination of two materials (Polycarbonate and Carbon Fiber) in a heat merge process to make a high-pressure desalination membrane housing reduces the weight of the housing and is very strong to withstand the high pressures used for RO/desalination by the system;

11. To address problem of replacing RO membranes in the field, the disclosed system can use two screw-on membrane end caps that are relatively very easy to remove in the field and without the need for special tools. The end caps can be designed for such easy removal;

12. In one implementation the transparent/clear polycarbonate housing, or pressure differential sensor for the NEPHROS, or other filter device such as an ultra, nano, or micro filter allows the operator to confirm that the filter is properly installed and whether it needs flushing. With the housing, the filter can easily be drained for safe transport of the NEPHROS or other filters. The housing can be made longer to accommodate two or more NEPHORS or other filters for larger systems and higher water per minute flow rate;

13. By providing transparent/clear housings for the pre-filters the user/operator can easily determine the status of the filters and know if one or more of the filters needs replacement. The user can also readily determine which type of filter(s) is (are) installed. With respect to the filters, there are several options, such as, but not limited to, micron size, type of filter, etc.;

14. The hose couplings to intake/pure/drain hoses can be, but is not limited to, a stainless steel garden hose style, quick-connect male/female fittings preferably provided with color coded bands to eliminate mistakes and allow the user/operator to quickly know/determine which hose goes with which connection. The stainless-steel fittings can be industrial quality and can preferably fit all standard size garden hose female couplings;

15. A rubber fitting may be, but is not limited to being, placed on top of the stainless-steel couplings which may be pressed down when the pelican type case is closed. This eliminates or prevents water leakage in the case during transport and when the hoses are moved. The rubber or similar material may be semi-permanently attached to the closing side of the case so that once closed it can cover over the couplings, or it may be loosely connected to the bottom handle by a stainless-steel wire or chain and manually placed on top of couplings before closing the case;

16. The system is preferably not attached to the case and can be entirely removed from the case preferably by the use of a top and bottom handle that can be provided for easy access to the internal components of the system for troubleshooting, performing maintenance, removing water from inside the case, etc. This also allows the case to be used as a water reservoir for flushing the system/unit or for easily replacing the entire case if needed. Preferably, the handles on the top and bottom of the system/unit can be attached such that they fit perfectly when the case is closed. Once the case is closed the handles can fit exactly inside the unit, keeping it tightly in place without having to attach the system to the body of case and interfering with the integrity of the case (i.e., PELICAN style case, etc.);

17. An exemplary 12V TDS (Total Dissolved Solids) Controller may be provided and in conjunction with the electro-valve can reroute bad water to address the issue of contaminated water possibly mixing with the clean/treated water. Preferably, the default ‘open’ electro-valve only receives electrical current once the TDS value is higher than a preset range. The electro-valve when closed, directs water flow to the desalination waste/particle filter flush water discharge hose;

18. Where no external electrical power is available and there is no internal battery, or the internal battery is drained/depleted, the system may be configured to still operate in a default filtration mode position which allows for garden hose level pressure for water flow through the system/unit and/or also a gravity feed to direct the water through the system/unit;

19. During battery power mode, the unit is completely safe: 12-24V DC—all water filtration powered devices can work (pumps, electro-valves, UV lamp, TDS Counter are all powered by low voltage 12V or 24V). Thus, the system can operate for its intended purposes without the use of potentially dangerous electrical currents;

20. The preferred UV LED lamp for system can operate at between about 255 and about 265 nm wavelengths. A radiation sensor can be provided that measures the total energy produced inside the lamp. This ensures that an adequate disinfection is still active as individual LED bulbs begin to burn out or if they become broken, such as through transit/transport/use. Once below the threshold the system preferably shuts down;

21. The system/unit can be provided with a serpentine water path and/or multiple passes to assure enough contact time within a small chamber of the water with the UV lamp. This also allows for a smaller chamber and for conserving space;

22. The system is preferably provided with or can work in connection with an extended range compact floating intake pump to address issues with water sources located away from the system. The preferred extended range pump can be sealed and waterproof, powered by an internal battery or external power source, has double pre-filters and a variable angle inlet piece underneath the pump. The pump can typically run on its batteries for 4-6 hours supplying water from a distant water source preferably up to 30 meters away from the unit with no need of a power cable. Waterproof cable connections allow it to be plugged into the pump to both charge batteries and/or power pump. A small waterproof Solar Panel can be positioned on the floating pump and plugged into the waterproof plug to charge batteries while the pump is supplying water on battery power.

The disclosed novel system and method treats a wide range of water sources (from sea water to lakes, ponds, rivers, wells and tap, pool or flood water) through a series of stages. Depending on the use of product water, source or available power, the unit can either process the water through a particle filter or RO purification/desalination membrane. The water unit can be powered by the internal Power Bank, external AC power supply (90-260V, 40-70 Hz), or external 12V or 24V batteries. The Power Bank can be removed from the unit and used as a separate Power Bank outside the unit, charged externally or internally.

Accordingly, the disclosed system and method provides for a portable desalination and/or filtration only system that can be provided with an integral power source and can also be powered by any AC, DC, 12 v, 24 v and solar power source in order to provide for true independence in any environment. The system is also preferably provided with a universal inverter and internal rechargeable battery pack. Furthermore, the preferred push button or one-knob operation also provides for an extremely user-friendly system. Thus, a novel universal water purification system and method that can desalinate salt water or just filter fresh water is provided herein.

The word “line” refers to any item capable of transporting fluid, including, without limitation, pipes, piping, tubes, pipelines, tubing, conduits, hoses, cannulas, cylinders, etc.

The word “frame” or “housing” refers to the structure that is used for containing/securing the various components of the system. The frame or housing is not considered limited to any particular shape or dimensions, but in a preferred embodiment, should be sized and shape to allow it to hold the system components and fit within the desired carrying case, with the carrying case preferably being able to be closed. However, it is also within the scope of the disclosure, that the carrying case does not have to be fully closed. In one non-limiting embodiment, the carrying case can be constructed from a material(s) that allow it to float at water surface while the frame/housing and system components are disposed within the carrying case.

It should be understood that the exemplary embodiments described herein should be considered in a descriptive sense only and not for purposes of limitation. Descriptions of features or aspects within each embodiment should typically be considered as available for other similar features or aspects in other embodiments. While one or more embodiments have been described with reference to the Figure, it will be understood by those of ordinary skill in the art that various changes in form and details may be made therein without departing from their spirit and scope.

All components of the described system and their locations, electronic, fluid and mechanical communication/connection methods between the system components, pumps, power sources, lamp sources, filtering media, fluid flow diverters/valves, dimensions, materials, cases, values, etc. discussed above or shown in the drawings, if any, are merely by way of example and are not considered limiting and other component(s) and their locations, electronic, fluid and mechanical communication/connection methods, pumps, power sources, lamp sources, filtering media, fluid flow diverters/valves, dimensions, materials, cases, values, etc. can be chosen and used and all are considered within the scope of the disclosure.

Dimensions of certain parts as shown in the drawings may have been modified and/or exaggerated for the purpose of clarity of illustration and are not considered limiting.

Unless feature(s), part(s), component(s), characteristic(s) or function(s) described in the specification or shown in the drawings for a claim element, claim step or claim term specifically appear in the claim with the claim element, claim step or claim term, then the inventor does not consider such feature(s), part(s), component(s), characteristic(s) or function(s) to be included for the claim element, claim step or claim term in the claim for examination purposes and when and if the claim element, claim step or claim term is interpreted or construed. Similarly, with respect to any “means for” elements in the claims, the inventor considers such language to require only the minimal number of features, components, steps, or parts from the specification to achieve the function of the “means for” language and not all of the features, components, steps or parts describe in the specification that are related to the function of the “means for” language.

While the system and method has been described and disclosed in certain terms and has disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

What is claimed is:

1. A portable system for producing potable water and capable of both water filtration and desalination, the portable system comprising:
a main fluid line adapted for fluid communication with a source of water;
a water injection device in fluid communication with the main fluid line for feeding at least one of fresh water, dissolved solid containing water, or salt water from the source of water into the main fluid line for further processing;
one or more filters disposed after the water injection device to filter the fresh water, dissolved solids containing water, or saltwater flowing through the main fluid line once the fresh water, dissolved solids containing water or saltwater is fed by the water injection device;
a disinfecting device for exposing fresh water, dissolved solid containing water, or salt water filtered by the one or more filters to at least one of a ultraviolet (UV) light, chlorine, disinfection liquid, disinfecting gas, ozone, post filtration filter, or ultrasonic frequencies for sterilization;
a multi-directional valve in fluid communication with the main fluid line to selectively direct the fresh water, dissolved solid containing water, or salt water exposed to one of or more of, the UV light, chlorine, disinfecting liquid, disinfecting gas, or ultrasonic frequencies to one of a nano, ultra, micro filter system and to selectively based on a detected level of total dissolve solids from the source of water direct the feed water exposed to one of the UV light, chlorine, disinfection liquid, disinfecting gas, ozone, post filtration filter to a desalination system;
the one of the nano, micro, or ultra-filter system comprising:
a) a first secondary fluid line in fluid communication with the valve, and
one or more particle filters disposed within or as part of the first secondary fluid line for filtering suspended solids from fresh water directed into the first secondary fluid line by the multi-directional valve; and
the desalination system including:
a) a second secondary fluid line in fluid communication with the multi-directional valve, the multi-direction valve including at least one of a 3-way valve or two single valves, and
b) at least one of a reverse osmosis (“RO”) purification/desalination membrane, a graphene filter, or a carbon nanotube (CNT) disposed within or as part of the second secondary fluid line for purifying and desalinating salt water directed into the second secondary fluid line by the multi-directional valve; and
a fluid output line for receipt of clean water exiting the at least one of a nano, ultra, carbon, or micro-filter and exiting the at least one of the RO purification/desalination membrane, the graphene filter, or the carbon nanotube (CNT).

2. The portable system of claim 1 further comprising a removable frame mounting the water injection device, the one or more filters, ultraviolet light emitting diodes (UVC-LED) that emit ultraviolet light, the multi-directional valve, the at least one of the nano, carbon, ultra, or micro filter system and the desalination system.

3. The portable system of claim 1 wherein the one or more filters are a disc filter, a sediment filter, and a carbon filter in fluid communication with each other and filtering the water drawn in through the water injection device to introduce water into the system.

4. The portable system of claim 1 wherein the multi-directional valve in fluid communication with the main fluid line either automatically directs the fresh water exposed to one of the UV light, chlorine, disinfecting liquid, disinfecting gas, or ultrasonic frequencies to at least one of the nano, micro, carbon, or ultra-filter system or automatically directs the saltwater exposed to at least one of the UV light, chlorine, disinfecting liquid, disinfecting gas, or ultrasonic frequencies to the desalination system based on a detected level of chlorides or total dissolved solids in the main fluid line.

5. The portable system of claim 1 further comprising a first filter fluid output line for receipt of wastewater exiting the one or more particle filters; and a normally closed valve disposed within or as part of the first particle filter fluid output line controlling the flow and discharge of wastewater out of the first filter fluid output line.

6. The portable system of claim 1 further comprising a first desalination output line for receipt of water exiting the desalination system, and a normally opened electro valve disposed within or as part of a first desalination membrane fluid output fluid line controlling the flow of clean water that was either filtered by the first filter or purified/desalinated by the purification/desalination membrane.

7. The portable system of claim 3 further comprising a removable frame coupled with at least one of a first nano, ultra, micro, or carbon filter fluid output line for receipt of wastewater exiting the first-filter, a first desalination system fluid output line for receipt of water exiting the desalination system, and a discharge/wastewater outlet extending out of the removable frame and in fluid communication with at least one of the first nano, micro, ultra, or carbon filter fluid output line, and a clean water outlet extending out of the frame and in fluid communication with the first desalination system fluid output line.

8. The portable system of claim 7 further comprising a suitcase for removable coupling of and portable transportation of the removable frame, the suitcase having a rubber fitting to prevent leakage during transport and one or more carrying handles.

9. The portable system of claim 1 wherein the water injection device includes at least one of a fluid pump, a suction pump, a gravity fed device and an external water pressurizing device.

10. The portable system of claim 8 further comprising a water inlet extending out from the frame and in fluid communication with the main fluid line.

11. A portable system for producing consumable water and capable of both water filtration and water desalination, comprising:
a main fluid line adapted for fluid communication with a source of water;
at least one of a main pump, an external pump, a tap water outlet, and a gravity feed device in fluid communication with the main fluid line for drawing in water from the source of water into the main fluid line for further use;
one or more filters disposed after the main pump and provided for filtering water flowing through the main fluid line once the water is drawn in by the at least one of the main pump, the external pump, the tap water outlet, and the gravity feed device;
an ultraviolet (UV) LED lamp positioned near the main fluid line after the one or more filters for exposing water filtered by the one or more filters to UV light for sterilization of the water exposed to the UV light;
at least one of a multi-directional valve or two two-way valves in fluid communication with the main fluid line to selectively direct the UV light exposed water to a first secondary fluid line and a second secondary fluid line;
a particle filter disposed within or as part of the first secondary fluid line for filtering water directed into the first secondary fluid line by the at least one of the multi-directional valve or two two-way valves;
a first particle filter fluid output line for receipt of wastewater exiting the particle filter;
a second particle filter fluid output line for receipt of clean water existing the particle filter;
a normally closed electro valve disposed within or as part of the first particle filter fluid output line controlling the flow and discharge of wastewater out of the first particle filter fluid output line;
a desalination system disposed within or as part of the second secondary fluid line for purifying and desalinating water directed into the second secondary fluid line by the at least one of the multi-directional valve or the two two-way valves;
a desalination system fluid output line for receipt of water exiting the desalination system,
wherein the second particle filter fluid output line in fluid communication with the first desalination system output line;
a normally opened electro valve disposed within or as part of the desalination system fluid line controlling the flow of clean water that was either filtered by the particle filter or purified/desalinated by the desalination system;
at least one of the main pump, external pump, tap water outlet, and a gravity feed device, UV LED lamp, the one or more filters, the particle filter and the desalination system coupled with a housing;
a discharge/wastewater hose coupling outlet extending out of the housing and in fluid communication with the first particle filter fluid output line;
a clean water hose coupling outlet extending out of the housing and in fluid communication with the first desalination system fluid output line;
a hose coupling water inlet extending out of the housing and in fluid communication with the main fluid line; and
a rigid suitcase for removably receipt of and portable transportation of the housing, the suitcase having one or more carrying handles, wherein the suitcase and the housing weighing under one hundred pounds.

12. The portable system of claim 11 further comprising a positive displacement pump disposed at a location of the source of water for pushing water from the source of water towards the main fluid line where the water can then be filtered or purified/desalinated.

13. The portable system of claim 11 wherein the main pump is a suction pump or a positive displacement pump, external well pump and wherein one or more filters include a disc filter, a sediment filter or a carbon filter in fluid communication with each other, and wherein the one or more filters filter the water drawn in through the suction pump or positive displacement pump, external well pump.

14. The portable system of claim 11 further comprising a battery pack for providing power to the UV LED lamp and electro valves.

15. A method for producing consumable water from both fresh water and salinized water, the method comprising:
receiving water via a main fluid line from a source of water;
sensing a level at least one of dissolved salinized or total dissolved solid (TDS) in the water received via the main fluid line;
filtering the water received via the main fluid line with one or more filters;
in response to sensing the level of at least one of salinized dissolved solids or total dissolved solid (TDS) in the water is below a predetermined threshold, automatically directing with at least one of a multi-directional valve or multiple two way valves the filtered water to a particle filter system;
in response to sensing the level of at least one of salinized solids or total dissolved solid (TDS) in the water exceeding a predetermined threshold, automatically directing with the multi-directional valve the filtered salinized water to a desalination system; and
outputting via a fluid output line clean water exiting the particle filter system or exiting the desalination system.

16. The method as recited in claim 15 wherein filtering the water received via the main fluid line with one or more filters comprises:
exposing the water received via the main fluid line to at least one of UV light, ultrasonic frequencies, chlorine, disinfecting liquid, disinfecting gas, or ozone.

17. The method as recited in claim 15 wherein the particle filter system includes at least one of a nano, a micro, or an ultra-filter system, and wherein the desalination system includes a reverse osmosis system.

18. The method as recited in claim 15 further comprising:
directing water through the main line with a main pump; removably attaching a frame to a hand carriable suitcase; and
attaching the main pump, the particle filter system, the one or more filters and the desalination system to the frame.

19. The method as recited in claim 18 further comprising:
removing from the suitcase the main pump, the particle filter system, the one or more filters and the desalination system.

20. The method as recited in claim 15 further comprising:
drawing in with a suction pump at least one of fresh water or salinized water containing at least one of salinized dissolved solids or high total dissolved solid (TDS) from the source of water into the main fluid line for further processing.
